(19) United States
(12) Patent Application Publication
(10) Pub. No.: US 2025/0308275 A1
(43) Pub. Date: Oct. 2, 2025

(54) Method to Use Edge Computing to Detect Non-Payload Encoding Visual Features for Optical Character Recognition

(71) Applicant: ZEBRA TECHNOLOGIES CORPORATION, Lincolnshire, IL (US)

(72) Inventors: Matthew Lawrence Horner, Sound Beach, NY (US); Anatoly Kotlarsky, Churchville, PA (US); Miroslav Trajkovic, Setauket, NY (US)

(21) Appl. No.: 18/621,091

(22) Filed: Mar. 28, 2024

(51) Int. Cl. G06V 30/24; G06F 40/174; G06K 7/14; G06V 10/40; G06V 10/774; G06V 10/82; G06V 10/94; G06V 20/62; G06V 30/18; G06V 30/19; G06V 40/16; H04N 23/611

(52) U.S. Cl. CPC G06V 30/24; G06K 7/1413; G06K 7/1417; G06V 10/40; G06V 10/774; G06V 10/82; G06V 10/955; G06V 20/62; G06V 30/18; G06V 30/19147; G06V 40/171; H04N 23/611; G06F 40/174

(57) ABSTRACT

Imaging devices, systems, and methods for determining whether an object is within range to be decoded based on a sharpness of the object in a captured image are described herein. An example device includes: an imaging assembly configured to capture image data of an object appearing in a field of view (FOV); one or more processors; and one or more computer-readable media storing machine readable instructions that, when executed, cause the one or more processors to: (i) capture, using the imaging assembly, the image data of the object appearing in the FOV; (ii) attempt to decode the image data of the object; (iii) responsive to an unsuccessful attempt to decode the image data, detect a non-payload encoding visual feature; and (iv) responsive to detecting the non-payload encoding visual feature, transmit, to an edge-computing module, a request for an optical character recognition (OCR) operation to be performed for the object.

### BACKGROUND

Barcode reading systems have long been used to capture barcode data, which is then used to look up information regarding the item in question. However, as traditional systems improve the imaging and capturing processes, additional hybrid uses for barcode reading systems become more desirable. In particular, some items may include additional information beyond what is encoded in a barcode or other such indicia but which may be important for the user of the barcode reading system. For example, a user may need to capture information on a driver's license (e.g., to determine whether a customer is of a proper age for purchasing alcohol, to determine customer information for a rewards account, to determine a user's identity, etc.) that is not stored in a payload-encoding indicia. Traditionally, a user must manually change from a barcode scanning mode to an image analysis mode, requiring additional bandwidth and network resource usage by the barcode reading system and/or communicatively coupled computing devices. Further, a user may become distracted or be unaware of the need to change between modes, introducing additional human error in addition to slowing the user's workflow. Attempts to communicate with a host computing device to help enter the image analysis mode may require specialized software or may cause the imaging device to constantly attempt to perform image analysis, drastically increasing resource and power usage. As such, a system that is able to automatically detect when to change between a barcode scanning mode and an image analysis mode is desirable.

### SUMMARY

In an embodiment, an imaging device for determining whether an object is within range to be decoded based on a sharpness of the object in a captured image is provided. The imaging device includes: an imaging assembly configured to capture image data of an object appearing in a field of view (FOV); one or more processors; and one or more computer-readable media storing machine readable instructions that, when executed, cause the one or more processors to: (i) capture, using the imaging assembly, the image data of the object appearing in the FOV; (ii) attempt to decode the image data of the object; (iii) responsive to an unsuccessful attempt to decode the image data, detect a non-payload encoding visual feature; and (iv) responsive to detecting the non-payload encoding visual feature, transmit, to an edge-computing module, a request for an optical character recognition (OCR) operation to be performed for the object.

In a variation of this embodiment, the non-payload encoding visual feature includes a human face.

In another variation of the embodiment, the non-payload encoding visual feature includes a non-payload encoding indicia.

In another variation of the embodiment, the image data is first image data and the one or more computer-readable media stores additional machine readable instructions that, when executed, cause the one or more processors to: responsive to detecting the non-payload encoding visual feature, capture, using the imaging assembly, second image data of the object appearing in the FOV; wherein the request for the OCR operation to be performed includes the second image data of the object.

In another variation of the embodiment, detecting the non-payload encoding visual feature is initiated automatically responsive to the unsuccessful attempt.

In yet another variation of the embodiment, detecting the non-payload encoding visual feature includes: detecting the non-payload encoding visual feature using a trained algorithm.

In still yet another variation of the embodiment, the one or more computer-readable media stores additional machine readable instructions that, when executed, cause the one or more processors to: generate the trained algorithm by training an algorithm to detect a non-payload encoding visual feature.

In another variation of the embodiment, the imaging device further comprises a housing disposed to house: the imaging assembly; the one or more processors; and the one or more computer-readable media.

In yet another variation, the housing is further disposed to house the edge-computing module.

In another embodiment, an imaging system is provided. The imaging system includes: an imaging assembly configured to capture image data of an object appearing in a field of view (FOV); and one or more computer-readable media storing machine readable instructions that, when executed, cause the imaging system to: (i) capture, using the imaging assembly, the image data of the object appearing in the FOV; (ii) attempt to decode the image data of the object; (iii) responsive to an unsuccessful attempt to decode the image data, detect a non-payload encoding visual feature; and (iv) responsive to detecting the non-payload encoding visual feature, perform an optical character recognition (OCR) operation for the object at an edge-computing module.

In a variation of the embodiment, the imaging system further comprises: an imaging device including the imaging assembly and the one or more computer-readable media; and a computing device including the edge-computing module, the computing device communicatively coupled to the imaging device.

In a further variation of the embodiment, the imaging device further includes: a housing disposed to house: the imaging assembly; the one or more computer-readable media; and the computing device.

In yet another variation of the embodiment, the imaging system further comprises an imaging device including: the imaging assembly; the one or more computer-readable media; and the edge-computing module.

In still another variation of the embodiment, the non-payload encoding visual feature includes a human face.

In still yet another variation of the embodiment, the non-payload encoding visual feature includes a non-payload encoding indicia.

In another variation of the embodiment, the image data is first image data and the one or more computer-readable media stores additional machine readable instructions that, when executed, cause the imaging system to: responsive to detecting the non-payload encoding visual feature, capture, using the imaging assembly, second image data of the object appearing in the FOV; wherein the OCR operation is based on the second image data of the object.

In yet another variation of the embodiment, detecting the non-payload encoding visual feature is initiated automatically responsive to the unsuccessful attempt.

In still another variation of the embodiment, detecting the non-payload encoding visual feature includes: detecting the non-payload encoding visual feature using a trained algorithm.

In still yet another variation of the embodiment, the one or more computer-readable media stores additional machine readable instructions that, when executed, cause the imaging system to: generate the trained algorithm by training an algorithm to detect a non-payload encoding visual feature.

In another variation of the embodiment, performing the OCR operation includes: detecting one or more fonts for text associated with the object; and analyzing the text to extract information associated with the object.

In yet another variation of the embodiment, the one or more computer-readable media stores additional machine readable instructions that, when executed, cause the imaging system to: pre-populate one or more information fields of a form associated with the object or a user related to the object.

In still another variation of the embodiment, the analyzing the text is performed via a neural network.

In yet another embodiment, a method in an imaging system including an imaging assembly configured to capture image data of an object appearing in a field of view (FOV) and an edge-computing module is provided. The method includes: capturing, by one or more processors and using the imaging assembly, the image data of the object appearing in the FOV; attempting to decode the image data of the object; responsive to an unsuccessful attempt to decode the image data, detecting a non-payload encoding visual feature; and responsive to detecting the non-payload encoding visual feature, performing an optical character recognition (OCR) operation for the object at the edge-computing module.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1A illustrates an isometric view of an example bioptic barcode reader functioning as an imaging device;

FIG. 1B illustrates a front perspective view of an example handheld barcode reader functioning as an alternative example imaging device to that of FIG. 1A;

FIG. 1C illustrates a back perspective view of the handheld barcode reader of FIG. 1B;

FIG. 2 illustrates a block diagram of an example imaging device such as the example barcode readers of FIGS. 1A-1C;

FIG. 3 illustrates a block diagram of an example imaging system where an edge-computing module can perform operations as described herein at the imaging device and/or at a communicatively coupled computing device;

FIG. 4A illustrates a flow diagram of an example method for determining whether to perform a visual feature detection operation and/or an optical character recognition (OCR) operation, to be implemented in an imaging device and/or system such as those depicted in FIGS. 1A-3; and

FIG. 4B illustrates a flow diagram of an example method similar to that of FIG. 4A, but in which the imaging device and/or system determines whether to transmit a request for the OCR operation rather than determining whether to perform the OCR operation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The example imaging devices and/or systems disclosed herein utilize a decode operation on an imaging device to function as a trigger for determining whether to perform a non-payload encoding visual feature detection operation. As used herein, “non-payload encoding visual feature” refers to a feature on or part of an object that is not an indicia (e.g., a barcode, QR code, payload-encoding watermark, etc.), and therefore does not encode a payload, but may otherwise be indicative of additional information. Depending on the implementation, non-payload encoding visual features may include faces (e.g., human faces on an identification (ID) card, driver's license, membership card, etc.), predetermined marks (e.g., a lottery ticket indicator, a company logo, an arbitrary pattern, etc.), a non-payload encoding watermark, and/or any other such visual feature as described herein. The imaging system can use the non-payload encoding visual feature detection operation to determine whether to perform an optical character recognition (OCR) operation and/or transmit a request to perform an OCR operation to a computing device. As such, an imaging system implementing the techniques described herein allows for OCR operations to be performed automatically, without interrupting a workflow, using fewer network and computing resources, and/or other such improvements as described herein.

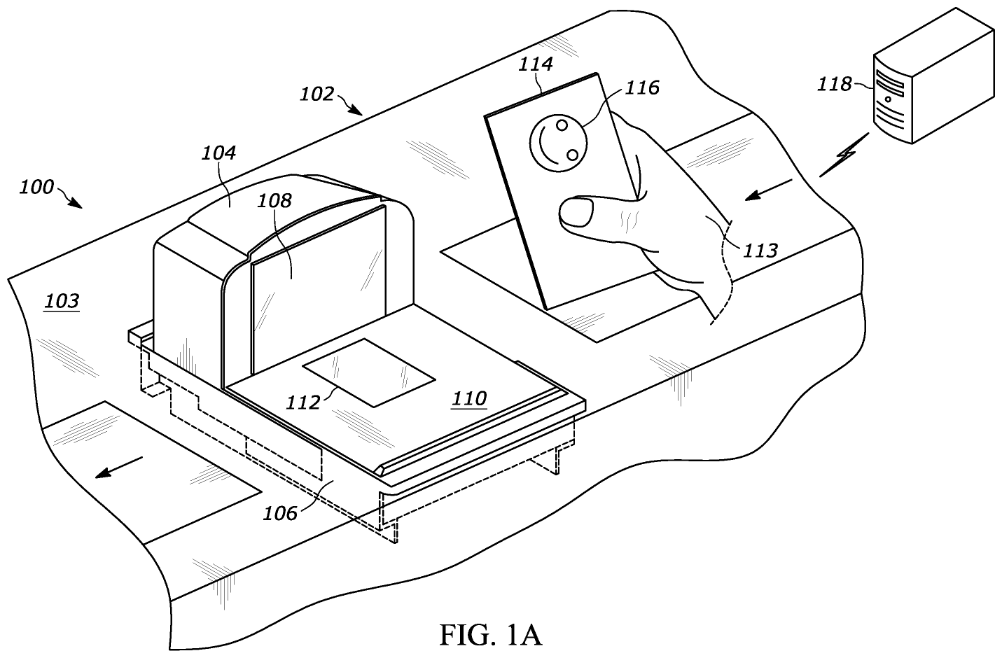

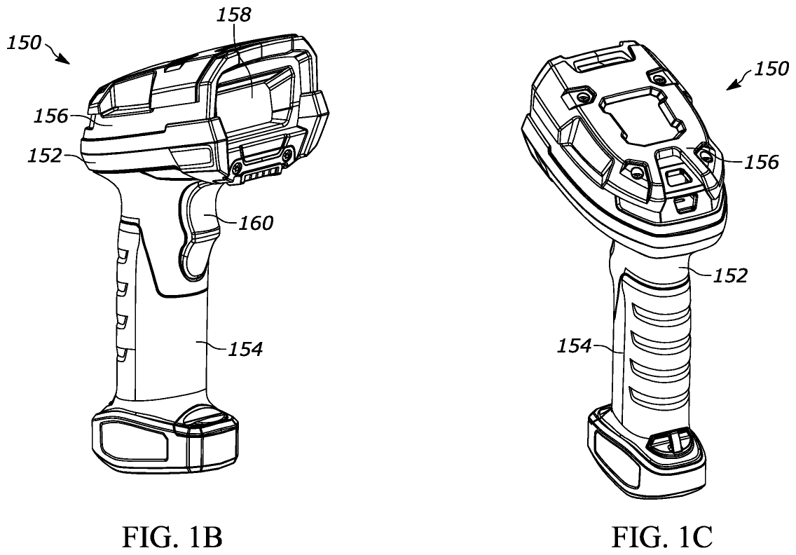

Referring to FIG. 1A, shown therein is an example imaging device embodied in a bioptic indicia reader 100. In the illustrated example, the bioptic indicia reader 100 is shown as part of a point-of-sale (POS) system arrangement 102 having the bioptic indicia reader 100 positioned within a workstation counter 103. Generally, the indicia reader 100 includes an upper housing 104 (also referred to as an upper portion, upper housing portion, or tower portion) and a lower housing 106 (also referred to as a lower portion, lower housing portion, or platter portion), collectively referred to as a housing. The upper housing 104 can be characterized by an optically transmissive window 108 positioned therein along a generally vertical (or upright) plane and one or more field of view (FOV) which passes through the window 108 and extends in a generally lateral direction. In some examples, a reference to a generally upright window shall be understood to mean a window inclined at an angle of up to 35 degrees relative to a vertical plane. The lower housing 106 can be characterized by a weight platter 110 or a cover that includes an optically transmissive window 112 positioned therein along a generally horizontal (also referred to as a transverse) plane and one or more FOV which passes through the window 112 and extends in a generally upward direction. In some examples, a reference to a generally horizontal window shall be understood to mean a window inclined at an angle of up to 25 degrees relative to a horizontal plane. The weight platter 110 is a part of a weigh platter assembly that generally includes the weight platter 110 and a scale (or load cell) configured to measure the weight of an object placed the top surface of the weight platter 110. By that virtue, the top surface of the weight platter 110 may be considered to be the top surface of the lower housing 106 that faces a product scanning region there above.

In operation, a user 113 generally passes an object 114 across a product scanning region of the indicia reader 100 in a swiping motion in some general direction, which in the illustrated example is right-to-left. A product scanning region can be generally viewed as a region that extends above the platter 110 and/or in front of the window 108 where indicia reader 100 is operable to capture image data of sufficient quality to perform imaging-based operations like decoding a barcode that appears in the obtained image data. It should be appreciated that while items may be swiped past the indicia reader 100 in either direction, items may also be presented into the product scanning region by means other than swiping past the window(s). In some implementations, when the object 114 comes into the any of the fields of view of the reader, the indicia reader 100 attempts to perform a decode operation. If the indicia reader 100 detects an indicia encoding a payload (e.g., a barcode, QR code, watermark, etc.) (not shown), the indicia reader 100 (and its respective modules and/or assemblies) captures and decodes the indicia on the object 114 before transmitting corresponding data (e.g., the payload of the indicia) to a communicatively coupled host 118 (commonly comprised of a point of sale (POS) terminal). In further implementations, (e.g., if the indicia reader 100 fails to perform the decode operation), the indicia reader 100 attempts to detect a non-payload encoding visual feature, such as a face, a predetermined symbol, etc.

Referring next to FIGS. 1B and 1C, illustrated therein is another exemplary imaging device. In particular, handheld imaging device 150 has a housing 152 with a handle portion 154, also referred to as a handle 154, and a head portion 156, also referred to as a scanning head 156. The head portion 156 includes a window 158 and is configured to be positioned on the top of the handle portion 154. The handle portion 154 is configured to be gripped by a reader user and includes a trigger 160 for activation by the user. Optionally included in an embodiment is also a base (not shown), also referred to as a base portion, that may be attached to the handle portion 154 opposite the head portion 156, and is configured to stand on a surface and support the housing 152 in a generally upright position. The handheld imaging device 150 can be used in a hands-free mode as a stationary workstation when it is placed on a countertop or other workstation surface. The handheld imaging device 150 can also be used in a handheld mode when it is picked up off the countertop or base station, and held in an operator's hand. In the hands-free mode, products can be slid, swiped past, or presented to the window 158 for the reader to initiate barcode reading operations. In the handheld mode, the handheld imaging device 150 can be moved towards a barcode on a product, and the trigger 160 can be manually depressed to initiate imaging of the barcode.

Other implementations may provide only handheld or only hands-free configurations. In the embodiment of FIGS. 1A and 1B, the handheld imaging device 150 is ergonomically configured for a user's hand, though other configurations may be utilized as understood by those of ordinary skill in the art. As shown, the handle 154 extends below and rearwardly away from the housing 152 along a centroidal axis obliquely angled relative to a central FOV axis of a FOV of an imaging assembly within the scanning head 156.

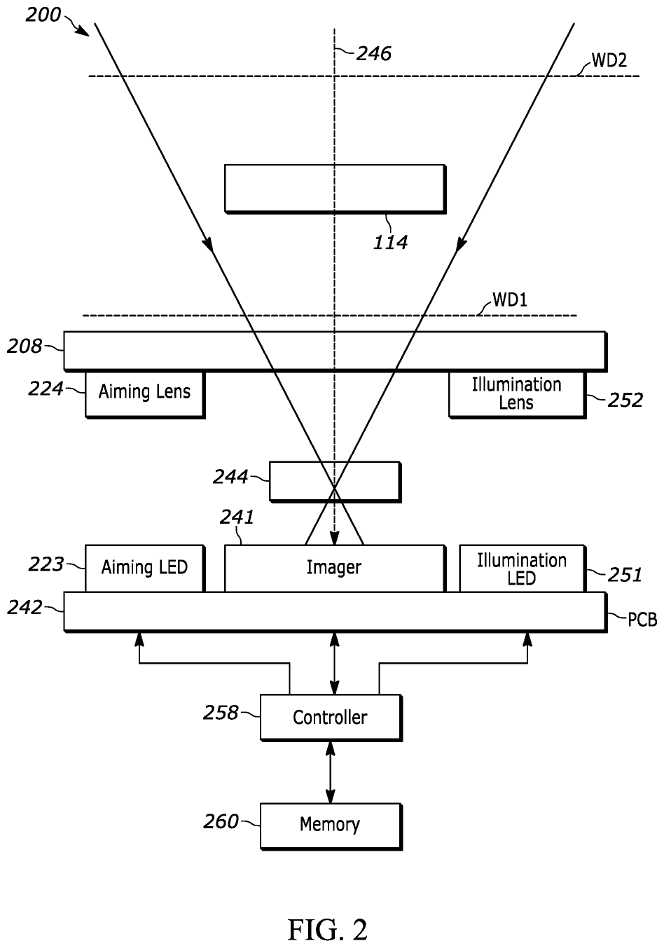

In some embodiments, an imaging assembly includes a light-detecting sensor or imager operatively coupled to, or mounted on, a printed circuit board (PCB) in the handheld imaging device 150 as shown in FIG. 2. In further embodiments, an illuminating light assembly is also mounted in the handheld imaging device 150. The illuminating light assembly may include an illumination light source and at least one illumination lens, configured to generate a substantially uniform distributed illumination pattern of illumination light on and along an object to be read by image capture, as described below with regard to FIG. 2.

Referring next to FIG. 2, a block diagram of an example architecture for an imaging device such as bioptic indicia reader 100 is shown. For at least some of the reader implementations, an imaging assembly of the imaging device 200 includes a light-detecting sensor or imager 241 operatively coupled to, or mounted on, a printed circuit board (PCB) 242 in the imaging device 200 as shown in FIG. 2. In an implementation, the imager 241 is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imager 241 over a field of view along an imaging axis 246 through the window 208. The imager 241 may also include and/or function as a monochrome sensor and, in further implementations, a color sensor. It should be understood that the terms “imager”, “image sensor”, and “imaging sensor” are used interchangeably herein. Depending on the implementation, imager 241 may include a color sensor such as a vision camera in addition to and/or as an alternative to the monochrome sensor. In some implementations, the imager 241 is or includes a barcode reading module (e.g., a monochromatic imaging sensor). In further implementations, the imager 241 additionally or alternatively is or includes a vision camera (e.g., a color imaging sensor). It will be understood that, although imager 241 is depicted in FIG. 2 as a single block, that imager 241 may be multiple sensors spread out in different locations of imaging device 200.

The return light is scattered and/or reflected from an object 114 over the field of view. The imaging lens 244 is operative for focusing the return light onto the array of image sensors to enable the object 114 to be imaged. In particular, the light that impinges on the pixels is sensed and the output of those pixels produce image data that is associated with the environment that appears within the FOV (which can include the object 114). This image data is typically processed by a controller (usually by being sent to a decoder) which identifies and decodes decodable indicia captured in the image data. Once the decode is performed successfully, the reader can signal a successful “read” of the object 114 (e.g., a barcode). The object 114 may be located anywhere in a working range of distances between a close-in working distance (WD1) and a far-out working distance (WD2). In an implementation, WD1 is about one-half inch from the window 208, and WD2 is about thirty inches from the window 208.

An illuminating light assembly may also be mounted in, attached to, or associated with the imaging device 200. The illuminating light assembly includes an illumination light source 251, such as at least one light emitting diode (LED) and at least one illumination lens 252, and preferably a plurality of illumination and illumination lenses, configured to generate a substantially uniform distributed illumination pattern of illumination light on and along the object 114 to be imaged by image capture. Although FIG. 2 illustrates a single illumination light source 251, it will be understood that the illumination light source 251 may include more light sources. At least part of the scattered and/or reflected return light is derived from the illumination pattern of light on and along the object 114.

An aiming light assembly may also be mounted in, attached to, or associated with the imaging device 200 and preferably includes an aiming light source 223, e.g., one or more aiming LEDs or laser light sources, and an aiming lens 224 for generating and directing a visible aiming light beam away from the imaging device 200 onto the object 114 in the direction of the FOV of the imager 241. It will be understood that, although the aiming light assembly and the illumination light assembly both provide light, an aiming light assembly differs from the illumination light assembly at least in the type of light the component provides. For example, the illumination light assembly provides diffuse light to sufficiently illuminate an object 114 and/or an indicia of the object 114 (e.g., for image capture). An aiming light assembly instead provides a defined illumination pattern (e.g., to assist a user in visualizing some portion of the FOV). Similarly, in some implementations, the illumination light source 251 and the aiming light source 223 are active at different, non-overlapping times. For example, the illumination light source 251 may be active on frames when image data is being captured and the aiming light source 223 may be active on frames when image data is not being captured (e.g., to avoid interference with the content of the image data).

In further implementations, the imaging device 200 may additionally emit an auditory cue, such as a chime, beep, message, etc. In still further implementations, the imaging device 200 may provide haptic feedback to a user, such as vibration (e.g., a single vibration, vibrating in a predetermined pattern, vibrating synchronized with flashing, etc.).

Further, the imager 241, the illumination source 251, and the aiming source 223 are operatively connected to a controller or programmed controller 258 (e.g., a microprocessor facilitating operations of the other components of imaging device 200) operative for controlling the operation of these components. In some implementations, the controller 258 functions as or is communicatively coupled to a vision application processor for receiving, processing, and/or analyzing the image data captured by the imager 241.

A memory 260 is connected and accessible to the controller 258. Preferably, the controller 258 is the same as the one used for processing the captured return light from the illuminated object 114 to obtain data related to the object 114. Though not shown, additional optical elements, such as collimators, lenses, apertures, compartment walls, etc. may be provided in the housing. Although FIG. 2 shows the imager 241, the illumination source 251, and the aiming source 223 as being mounted on the same PCB 242, it should be understood that different implementations of the imaging device 200 may have these components each on a separate PCB, or in different combinations on separate PCBs. For example, in an implementation of the imaging device 200, the illumination LED source is provided as an off-axis illumination (i.e., has a central illumination axis that is not co-axial with the central FOV axis).

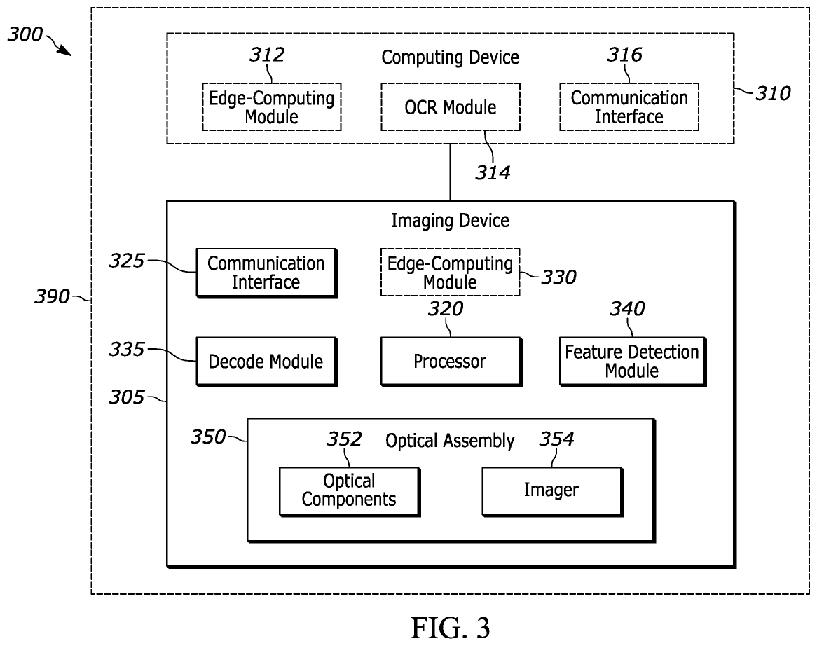

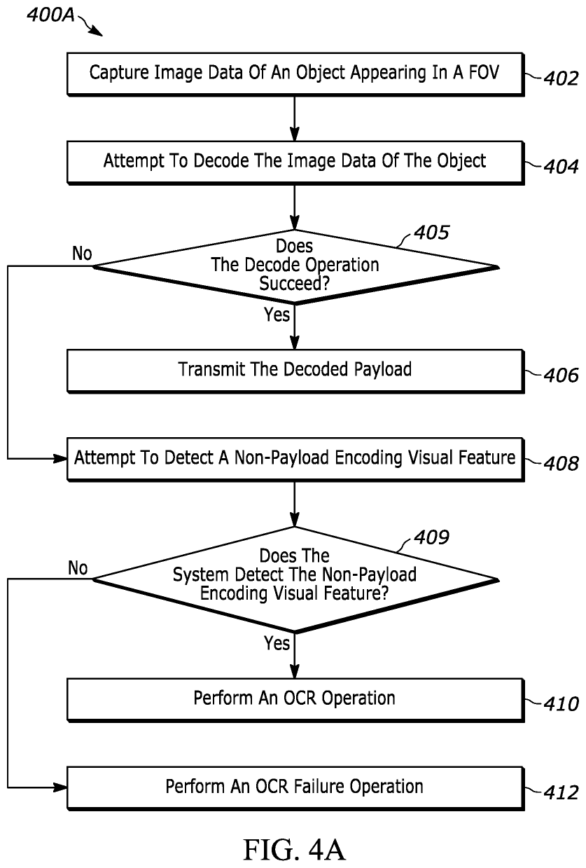

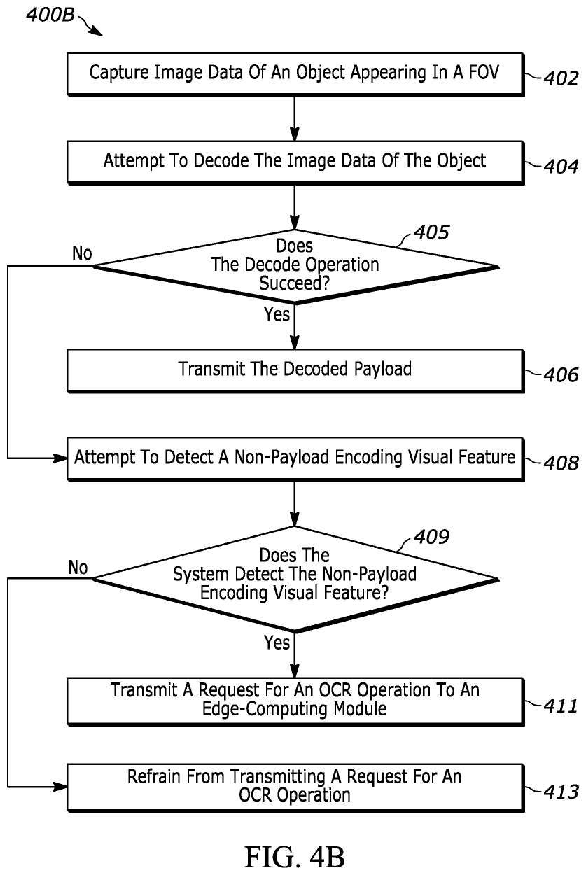

FIG. 3 is a block diagram of an example system 300 having an imaging device 305 that may be configured to implement the methods as described herein (e.g., method 400A of FIG. 4A, method 400B of FIG. 4B, etc.), and provide at least one of (i) the payload of decoded barcodes, indicia, payload encoding indicia, etc. or (ii) an indication of detected non-payload encoding visual features to a host computing device 310. The imaging device 305 may be, for example, a handheld scanner that may operate in a handheld and/or handsfree mode, a bioptic scanner, a machine vision system, a slot scanner, or the like that are configured to analyze visual features and/or decode barcodes and provide the payload of the decoded barcodes to the host computing device 310 via, for example, the communication interface 325. The imaging device 305 may also be, for example, a general-purpose computing device (e.g., a computer, a laptop, a mobile device such as a mobile phone, a tablet, etc.), a headset or other wearable device (e.g., an augmented reality headset, etc.), or any other type of computing device or system (i) having a communication interface and a camera for capturing images, and (ii) configurable to process such images for detecting visual features and/or determining barcode decoding parameters for a plurality of barcodes in an image, and for locating and decoding the barcodes. The host computing device 310 may be a point-of-sale (POS) station, a point-of-transaction station, an inventory management system, etc.

In some implementations, the imaging device 305 includes a decode module 335. Example decode modules 335 include and/or are communicatively coupled to a barcode decoder, which may include a programmable processor, programmable controller, graphics processing unit (GPU), digital signal processor (DSP), etc. capable of executing instructions to, for example, implement operations of the example methods described herein. Additionally and/or alternatively, the decode module 335 may include and/or be communicatively coupled to one or more logic circuits capable of, for example, implementing operations of the example methods described herein without executing software or instructions.

The example imaging device 305 includes the decode module 335 having a plurality of photosensitive elements to capture image data representing images of an environment in which the imaging device 305 is operating that falls within a FOV of the imaging device 305, the processor 320, and the feature detection module 340. The example system 300 includes one or more example processors 320 to generally control the system 300, and to provide the decoded payloads of barcodes decoded by the decode module 335, requests for OCR operations, data for OCR operations, feature detection indications, etc. to, for example, a host system via a communication interface 325. In some examples, the processor 320 receives an indication of data determined via OCR module 314, edge-computing module 312, etc. via the communication interface 325. The processor 320 can also transmit an indication of detection of a visual feature, decoding of a payload, and/or other such indications to a computing device 310 and/or other such host system device via the communication interface 325.

Example processors 320 include a programmable processor, programmable controller, GPU, DSP, etc. capable of executing instructions to, for example, implement operations of the example methods described herein. Additionally and/or alternatively, the processor 320 may include one or more logic circuits capable of, for example, implementing operations of the example methods described herein without executing software or instructions. In some implementations, the processor 320 may be a plurality of processors and/or processing cores, allowing for parallel operations to be performed by the imaging device 305.

The feature detection module 340 may be configured and/or trained (e.g., via a trained algorithm and/or model as described herein) to detect non-payload encoding visual features such as faces (e.g., facial detection), arbitrary or particular patterns, predetermined markings (e.g., logos), etc. The feature detection module 340 may transmit an indication of successful or failed detection to an edge-computing module 330 of the imaging device 305, an edge-computing module 312 of the computing device 310, and/or some other computing device (not shown).

In conventional systems, the imaging device 305 may omit a feature detection module 340 or may include a feature detection module 340 that relies on manual activation. As such, conventional systems may not have feature detection capabilities and/or may utilize such capabilities only when explicitly receiving a manual indication to change to such an operation mode, creating a recurring issue that adds strain to the system 300 (e.g., in the form of communications between the system 300 and a host (not shown)) as well as to the general workflow of the system 300. The instant system 300 may, therefore, improve overall operation by implementing additional functionality and/or reducing the overall resource requirements for such operations.

In some examples, the processor 320 controls the overall operation of the imaging device 305. For example, the processor 320 may control an optical assembly 350 to capture one or more images (e.g., via the optical components 352 and/or image sensor 354 (also referred to as an imager 354) of the optical assembly 350, as discussed below); control the decode module 335 to determine a set of barcode decoding parameters for decoding a plurality of barcodes in the one or more images, and attempt to decode the plurality of barcodes using first (i.e., starting with) the determined set of barcode decoding parameters; provide barcode payloads of decoded barcodes to the host computing device 310; execute an operating system; operate, in some implementations, an edge-computing module 330; respond to user or computing device 310 inputs received via the communication interface 325; execute one or more applications on behalf of a user; etc.

In some implementations, the edge-computing module 330 (and/or edge-computing module 312 of the computing device 310) performs edge-computing (also referred to as “computing at the edge”), a distributed computing paradigm in which a module or node of a distributed computing network performs computation and/or data storage closer to the sources of data generation (e.g., the imaging device 305 and/or computing device 310). Unlike conventional cloud computing, the edge-computing module 330 and/or 312 moves the capabilities and operations to the edge of the network, near the devices and sensors that collect data. Such proximity reduces latency, bandwidth usage, and reliance on a centralized infrastructure. In particular, in edge-computing, processing tasks are performed locally on the edge module(s) 330 and/or 312, allowing for real-time data analysis and quicker responses.

In some examples, the processor 320 and the edge-computing module 330 are implemented by the same device. In further implementations, the edge-computing module 312 is additionally or alternatively implemented on the computing device 310. In still further implementations, the edge-computing module is implemented separately from the imaging device 305 and computing device 310 (e.g., still within the housing 302, outside the housing 302, partially within the housing 302, etc.). The computing device 310 may additionally include an optical character recognition (OCR) module 314 configured to perform OCR operations, in conjunction with the edge-computing module 312 (e.g., via a communication interface 316 of the computing device 310 and the communication interface 325 of the imaging device 305), with another computing device (not shown), and/or alone.

Depending on the implementation, the feature detection module 340, the edge-computing module(s) 312 and/or 330, and/or the OCR module 314 include a trained algorithm and/or model. Depending on the implementation, the algorithm and/or model may be trained using various machine learning (ML) and/or artificial intelligence (AI) techniques. In some implementations, the algorithm and/or model may be trained on the computing device 310, the imaging device 305, another device in the system 300 (not shown), and/or an external device to the system 300 (not shown). Depending on the implementation, the algorithm and/or model may be trained using training data from the computing device 310, imaging device 305 (e.g., captured by a user performing the training), and/or external databases including historical image data and/or historical device data corresponding to historical images. The trained algorithm and/or model may then be applied to newly captured image data to determine whether a non-payload encoding visual feature has been detected and/or perform an OCR operation.

In various aspects, the trained algorithm and/or model may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the algorithm and/or model may comprise a library or package executed on the computing device 310 (or other computing devices not shown in FIG. 3). For example, such libraries may include, but are not limited to, the TENSORFLOW based library, the PYTORCH library, and/or the SCIKIT-LEARN Python library.

Machine learning, as referenced herein, may involve identifying and recognizing patterns in existing data in order to facilitate making predictions or identification for subsequent data (such as using the trained algorithm and/or model on newly captured data to (i) detect a non-payload encoding visual feature and/or (ii) perform OCR operations on image data for an object).

Machine learning model(s) may be created and trained based upon example data (e.g., “training data”) inputs or data (which may be termed “features” and “labels”) to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided to subsequent inputs for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by a server, computing device, or other such processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

Depending on the implementation, the edge-computing module(s) 312/330 and/or the OCR module 314 (and/or algorithms or models stored on such) are specifically trained to perform OCR operations. In some implementations, an OCR algorithm or model may be trained using labeled datasets consisting of images and corresponding ground truth text, as described above. During training, a training module (not shown) and/or training device (not shown) may adjust parameters to minimize the difference between predicted and actual text. Depending on the implementation, the OCR algorithm or model may be trained using supervised learning or unsupervised learning, as described herein.

In some implementations, such OCR operations may be or include the conversion of printed or handwritten text into machine-encoded (and therefore machine-readable) text. In particular, OCR operations may be or include accurately recognizing and interpreting characters from images or documents. The OCR operations may additionally be or include feature extraction (e.g., extraction of features such as edges, corners, and gradients from an input image to represent the characteristics of each character). Depending on the implementation, the OCR algorithm and/or model may perform or utilize histogram of oriented gradients (HOG) techniques, scale-invariant feature transform (SIFT) techniques, or convolutional neural networks (CNNs) for feature extraction. In some implementations (e.g., where multiple characters are present in an image), the OCR algorithm and/or model may additionally use or perform segmentation techniques to separate individual characters for recognition.

In further implementations, once features are extracted and characters segmented, the OCR module 314 and/or edge-computing modules 312/330 may utilize classification algorithms to identify each character. In some implementations, the classification algorithms may include machine learning algorithms like Support Vector Machines (SVM) or k-nearest neighbors (KNN), as well as deep learning models such as neural networks for classification tasks in OCR.

In some implementations, OCR operations may additionally include preprocessing steps such as image enhancement, noise reduction, and binarization to improve the quality of the input image and enhance the clarity of characters. Similarly, the OCR operations may additionally include postprocessing techniques like language modeling, spell checking, and context analysis to improve the accuracy of OCR results and correct errors introduced during the recognition process. Depending on the implementation, the edge-computing module(s) 312/330 and/or the OCR module 314 may perform the preprocessing steps in response to an indication from the feature detection module 340 (e.g., responsive to detecting a non-payload encoding visual feature as described herein).

Depending on the implementation, the imaging device 305 and the computing device 310 may be included in a shared housing 390. The housing, for example, may be for a bioptic indicia reader 100, a handheld imaging device 150, an imaging device 200, and/or any other such imaging device or system. As such, the edge-computing module 312 is kept close to the imaging device 305 as a source of data. In further implementations, the edge-computing module 312/330 and/or OCR module 314 may be on the imaging device 305 entirely. In still further implementations, the edge-computing module 312 and/or OCR module 314 may be on a separate device kept separate from the imaging device 305 (e.g., outside the housing 390), and an edge-computing module 330 may perform at least some of the operations at the imaging device 305.

The imaging device 305 includes an optical assembly 350 to form images of an environment in a FOV on a surface of the image sensor 354. The optical assembly 350 may include any number and/or type(s) of optical elements and/or components 352 including, for example, one or more lenses, filters, focus motors, apertures, lens holder, liquid lenses, or any other components and/or optical elements.

In some examples, the optical components 352 include any number and/or type(s) of focus components (e.g., motors, liquid lenses, etc.) to focus the optical assembly 350 on, for example, a barcode. In some examples, some of the optical components 352 (e.g., an autofocus controller) are implemented by the processor 320. Alternatively, the optical assembly 350 is a fixed-focus optical assembly.

While not shown in FIG. 3 for clarity of illustration, the imaging device 305 may include an aiming pattern generator configured to provide an illuminated aiming pattern to assist a user in directing the imaging device 305 toward a barcode of interest, and/or an illumination generator to emit light in a FOV to, for example, facilitate autofocus and/or improve the quality of image data captured by the image sensor 354 (e.g., as described with regard to FIG. 2).

Referring next to FIG. 4A, the method 400A illustrates a flow diagram of an example method for determining whether to perform an OCR operation (e.g., at an edge-computing module such as edge-computing module 330). Although the method 400A is described below with regard to system 300 and components thereof as illustrated in FIG. 3, it will be understood that other similarly suitable systems (e.g., including imaging and/or computing devices) and/or components thereof may be used instead (e.g., imaging device 200, indicia reader 100, etc.).

At block 402, the system 300 captures image data of an object appearing in a field of view (FOV) (e.g., via the optical assembly 350 of imaging device 305). In some implementations, the imaging device 200 captures the image data responsive to the object (e.g., object 114) entering a FOV of the system 300. In other implementations, the system 300 constantly captures a stream of image data and discards the stream of image data until the system 300 detects the object 114. In still further implementations, the system 300 constantly captures and stores a stream of image data but begins analysis and/or decoding of the image data as described herein responsive to detecting the presence of an object 114.

At block 404, the system 300 attempts to decode at least a portion of the image data of the object 114. In some implementations, the imaging device 305 attempts to decode the image data using a decode module (e.g., decode module 335 of FIG. 3). In further implementations, the imaging device 305 transmits the image data to a computing device (e.g., computing device 310).

Depending on the implementation, the system 300 uses the decode attempt as a trigger to activate an attempt to detect a non-payload encoding visual feature. As such, at block 405, the system 300 determines whether the decode operation succeeds. If so, then flow proceeds to block 406. Otherwise, if the decode operation does not succeed, the flow proceeds to block 408.

At block 406, the system 300 (e.g., the imaging device 305 of the system 300) transmits the decoded payload. Depending on the implementation, the system 300 and/or a communicatively coupled computing device may then proceed through various decoded payload operations (e.g., determining that a user is scanning a particular product based on the decoded payload, training an element of the system 300 based on the decoded payload, etc.).

At block 408, the system 300 attempts to detect a non-payload encoding visual feature. Depending on the implementation, the non-payload encoding visual feature may be a human face (e.g., on a driver's license or other such identification), a logo, a non-payload encoding watermark, a particular and/or arbitrary design, pattern, or marking (e.g., a design element indicative of a lottery ticket), etc. In some implementations, the imaging device 305 marks a final image in a frame sequence to store for use at block 408 in attempting to detect the non-payload encoding visual feature. If decode attempt at block 405 is successful, the imaging device 305 then discards the marked image at block 406.

In some implementations, the system 300 may use a trained algorithm (e.g., a trained machine learning (ML) and/or artificial intelligence (AI) algorithm) to detect the presence of the non-payload encoding visual feature, as described above (e.g., with regard to FIG. 3). For example, the system 300 may train (e.g., by using historical image data with labels and/or without labels to detect patterns) an algorithm to identify and/or otherwise detect faces or other such non-payload encoding visual features as described herein.

At block 409, the flow diverges based on whether the system 300 detects the non-payload encoding visual feature. If the system 300 detects the non-payload encoding visual feature, then flow proceeds to block 410. Otherwise, if the system 300 does not detect the non-payload encoding visual feature, the flow proceeds to block 412. It will be understood that, in some implementations, the order of blocks 409 and 405 may differ. For example, in some such implementations, the system 300 may attempt to perform the decode operation and attempt to detect the non-payload encoding visual feature in parallel (e.g., using multiple processing cores). In some such implementations, block 410 occurs responsive to both failing to decode an indicia and detecting the non-payload encoding visual feature, and block 412 occurs responsive to either succeeding in decoding the indicia or failing to detect the non-payload encoding visual feature.

At block 410, the system 300 (e.g., the imaging device 305) performs an OCR operation. By performing the OCR operation responsive to detecting the non-payload encoding visual feature, the system 300 may save computing resources compared to other techniques for implementing OCR without a manual indication (e.g., by always performing the OCR operation automatically). In some implementations, the imaging device 305 captures an additional set of images specifically on which to perform the OCR operations. In some such implementations, the imaging device 305 captures the additional images responsive to detecting the non-payload encoding visual feature(s) (e.g., at blocks 408 and 409).

In some implementations, the OCR operation may include reading one or more text elements associated with the object. For example, in implementations in which the object is an ID card (e.g., a driver's license, a state-issued ID card, a work badge, a member's reward card, an insurance card, etc.), the system 300 may read and store text written on the ID card using OCR analysis. In some such implementations, the text may include a name, a date of birth, an age, an identification number, an address, a date of registration, a date of expiration, medical status, etc. In further implementations, the system 300 automatically populates one or more fields of a form (e.g., stored on the computing device 310 or on an external device) using the OCR analysis of the text on the ID card.

As another example, the object may be a ticket (e.g., a lottery ticket, a train ticket, a venue ticket, etc.), receipt, or other such indication of purchase. In such implementations, the system 300 detects a symbol and/or predetermined pattern (e.g., that does not encode a payload and is therefore non-payload encoding) and performs an OCR operation to read text on the ticket. The text may include a name, ID number, date of birth, age, event number (e.g., lottery pull number, sports game number, recital number, etc.) and/or name, event-specific text (e.g., a seat number, a lottery number, etc.), and/or other such information. The system 300 may similarly automatically populate one or more fields of a form using the OCR analysis of the text on the ticket.

At block 412, the system 300 (e.g., the imaging device 305) performs an OCR failure operation. In some implementations, the OCR failure operation may be or include a shutdown operation (e.g., returning to a rest, offline, power-saving, or otherwise powered down mode). In further implementations, the OCR failure operation may be or include an indication to a user and/or a communicatively coupled computing device that the OCR operation has failed (e.g., transmitting a failure message, transmitting an error code, transmitting an indication that no proper visual feature was detected, etc.). In some such implementations, the system 300 then performs a shutdown operation as described above.

In still further implementations, the OCR failure operation may be or include a new operation unrelated to decoding operations and/or OCR operations. For example, the system 300 may determine to perform a security-related operation (e.g., movement detection, ticket switching detection, etc.). In yet still further implementations, the OCR failure operation may be or include a new attempt at the decode operation previously performed and/or a new decode operation.

FIG. 4B depicts a method 400B similar to method 400A, but in which the method 400B includes blocks 411 and 413 instead of blocks 410 and 412, respectively. At block 409, the flow diverges depending on whether the system 300 detects the non-payload encoding visual feature. In the system 300 does detect the non-payload encoding feature, then the flow proceeds to block 411. Otherwise, if the system 300 does not detect the non-payload encoding visual feature, then flow proceeds to block 413.

At block 411, the system 300 (e.g., imaging device 305) transmits a request for an OCR operation to an edge-computing module (e.g., edge-computing module 312). In some such implementations, the edge-computing module 312 performs the OCR operation (e.g., in conjunction with an OCR module 314, alone, in conjunction with a module of the imaging device 305, etc.) as described above. The edge-computing module 312 may then further use the OCR analysis generated by the OCR operation and/or transmit the OCR analysis to another computing device (e.g., the imaging device 305 and/or an external computing device) to perform further operations.

At block 413, the system 300 (e.g., imaging device 305) refrains from transmitting a request for an OCR operation. In some implementations, the imaging device 305 performs an additional operation as described with regard to block 412 above. In further implementations, the computing device 310 may instead perform the additional operation in response to not receiving the indication the request for an OCR operation. In some alternate implementations, the imaging device 305 transmits an indication to refrain from performing an OCR operation instead of the request for OCR operation, and the computing device 310 performs an additional operation as described with regard to block 412 in response to receiving the indication.

Embodiments of the present disclosure may have certain advantages over traditional approaches. For example, using a single assembly to provide both aiming light and a decode indication can reduce complexity, footprint, costs, etc. Similarly, providing a visible decode indication using the aiming light may improve a rate at which users recognize the indication, as auditory cues may be missed in a noisy or busy environment and an illumination system has a large FOV across which the system projects light, diffusing the light and reducing overall visibility.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging device, comprising:
an imaging assembly configured to capture image data of an object appearing in a field of view (FOV);
one or more processors; and
one or more computer-readable media storing machine readable instructions that, when executed, cause the one or more processors to:
capture, using the imaging assembly, the image data of the object appearing in the FOV;
attempt to decode the image data of the object;
responsive to an unsuccessful attempt to decode the image data, detect a non-payload encoding visual feature; and
responsive to detecting the non-payload encoding visual feature, transmit, to an edge-computing module, a request for an optical character recognition (OCR) operation to be performed for the object.

2. The imaging device of claim 1, wherein the non-payload encoding visual feature includes a human face.

3. The imaging device of claim 1, wherein the non-payload encoding visual feature includes a non-payload encoding indicia.

4. The imaging device of claim 1, wherein the image data is first image data and the one or more computer-readable media stores additional machine readable instructions that, when executed, cause the one or more processors to:
responsive to detecting the non-payload encoding visual feature, capture, using the imaging assembly, second image data of the object appearing in the FOV;
wherein the request for the OCR operation to be performed includes the second image data of the object.

5. The imaging device of claim 1, wherein detecting the non-payload encoding visual feature is initiated automatically responsive to the unsuccessful attempt.

6. The imaging device of claim 1, wherein detecting the non-payload encoding visual feature includes:
detecting the non-payload encoding visual feature using a trained algorithm.

7. The imaging device of claim 6, wherein the one or more computer-readable media stores additional machine readable instructions that, when executed, cause the one or more processors to:
generate the trained algorithm by training an algorithm to detect a non-payload encoding visual feature.

8. The imaging device of claim 1, further comprising:
a housing disposed to house:
the imaging assembly;
the one or more processors; and
the one or more computer-readable media.

9. The imaging device of claim 8, wherein the housing is further disposed to house the edge-computing module.

10. An imaging system, comprising:
an imaging assembly configured to capture image data of an object appearing in a field of view (FOV); and
one or more computer-readable media storing machine readable instructions that, when executed, cause the imaging system to:
capture, using the imaging assembly, the image data of the object appearing in the FOV;
attempt to decode the image data of the object;
responsive to an unsuccessful attempt to decode the image data, detect a non-payload encoding visual feature; and
responsive to detecting the non-payload encoding visual feature, perform an optical character recognition (OCR) operation for the object at an edge-computing module.

11. The imaging system of claim 10, further comprising:
an imaging device including the imaging assembly and the one or more computer-readable media; and
a computing device including the edge-computing module, the computing device communicatively coupled to the imaging device.

12. The imaging system of claim 11, wherein the imaging device further includes:
a housing disposed to house:
the imaging assembly;
the one or more computer-readable media; and
the computing device.

13. The imaging system of claim 10, further comprising:
an imaging device including:
the imaging assembly;
the one or more computer-readable media; and
the edge-computing module.

14. The imaging system of claim 10, wherein the non-payload encoding visual feature includes a human face.

15. The imaging system of claim 10, wherein the non-payload encoding visual feature includes a non-payload encoding indicia.

16. The imaging system of claim 10, wherein the image data is first image data and the one or more computer-readable media stores additional machine readable instructions that, when executed, cause the imaging system to:
responsive to detecting the non-payload encoding visual feature, capture, using the imaging assembly, second image data of the object appearing in the FOV;
wherein the OCR operation is based on the second image data of the object.

17. The imaging system of claim 10, wherein detecting the non-payload encoding visual feature is initiated automatically responsive to the unsuccessful attempt.

18. The imaging system of claim 10, wherein detecting the non-payload encoding visual feature includes:
detecting the non-payload encoding visual feature using a trained algorithm.

19. The imaging system of claim 18, wherein the one or more computer-readable media stores additional machine readable instructions that, when executed, cause the imaging system to:
generate the trained algorithm by training an algorithm to detect a non-payload encoding visual feature.

20. The imaging system of claim 10, wherein performing the OCR operation includes:
detecting one or more fonts for text associated with the object; and
analyzing the text to extract information associated with the object.

21. The imaging system of claim 20, wherein the one or more computer-readable media stores additional machine readable instructions that, when executed, cause the imaging system to:
pre-populate one or more information fields of a form associated with the object or a user related to the object.

22. The imaging system of claim 20, wherein the analyzing the text is performed via a neural network.

23. A method in an imaging system including an imaging assembly configured to capture image data of an object appearing in a field of view (FOV) and an edge-computing module, the method comprising:
capturing, by one or more processors and using the imaging assembly, the image data of the object appearing in the FOV;
attempting to decode the image data of the object;
responsive to an unsuccessful attempt to decode the image data, detecting a non-payload encoding visual feature; and
responsive to detecting the non-payload encoding visual feature, performing an optical character recognition (OCR) operation for the object at the edge-computing module.
